(19) United States
(12) Patent Application Publication
(10) Pub. No.: US 2026/0170347 A1
(43) Pub. Date: Jun. 18, 2026

(54) CONTEXT AWARE OBSERVATIONAL AND GROUP LEARNING ENVIRONMENT

(71) Applicant: International Business Machines Corporation, Armonk, NY (US)

(72) Inventors: Sridevi Kannan, Chennai (IN); Sathya Santhar, Chennai (IN); Shweta Vohra, Bangalore (IN); Sarbajit Kumar Rakshit, Kolkata (IN)

(73) Assignee: International Business Machines Corporation, Armonk, NY (US)

(21) Appl. No.: 18/985,882

(22) Filed: Dec. 18, 2024

(51) Int. Cl. G06N 3/094; G06N 3/045; G06N 3/0475

(52) U.S. Cl. CPC G06N 3/094; G06N 3/045; G06N 3/0475

(57) ABSTRACT

An embodiment includes determining by a system, responsive to detecting a first profile performing an activity, a first quality metric of the first profile using a trained first neural network. The embodiment includes determining based on the first quality metric, a second profile performing the activity and a second quality metric of the second profile using a trained second neural network. The embodiment also includes transforming, if the second profile is available, an interactive environment using a trained third neural network based on the first profile and the second profile wherein the transforming overlays an image of the second profile in the interactive environment wherein the image is selected based on at least a difference between the first quality metric and the second quality metric and the first profile and the second profile interact with the image.

### BACKGROUND

The present invention relates generally to artificial intelligence. More particularly, the present invention relates to a method, system, and computer program for Context Aware Observational and Group Learning Environment.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

### SUMMARY

The illustrative embodiments provide for Context Aware Observational and Group Learning Environment. An embodiment includes determining by a system, responsive to detecting a first profile performing an activity, a first quality metric of the first profile using a trained first neural network. The embodiment includes determining based on the first quality metric, a second profile performing the activity and a second quality metric of the second profile using a trained second neural network. The embodiment also includes transforming, if the second profile is available, an interactive environment using a trained third neural network based on the first profile and the second profile wherein the transforming overlays an image of the second profile in the interactive environment wherein the image is selected based on at least a difference between the first quality metric and the second quality metric and the first profile and the second profile interact with the image.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an environment in accordance with an illustrative embodiment;

FIG. 3 depicts a block diagram of a first neural network in accordance with an illustrative embodiment;

FIG. 4 depicts a block diagram of a second neural network in accordance with an illustrative embodiment;

FIG. 5 depicts a block diagram of a third neural network in accordance with an illustrative embodiment;

FIG. 6 depicts a block diagram of an interactive environment in accordance with an illustrative embodiment;

FIG. 7 depicts a flowchart diagram in accordance with an illustrative embodiment; and

FIG. 8 depicts a system diagram in accordance with an illustrative embodiment.

### DETAILED DESCRIPTION

In any industrial floor, there may be different types of activities being performed, such as work comprising welding, riveting etc. where human workers are performing the activity manually with different tools and technologies. Different workers have different skills to perform the activity, and the quality of the manual activity depends on the skill level of the worker, quality of the tools and technologies used during manual activity, and at the same time, work environment, operational parameters etc. are influencing the quality of the activity is being performed.

While performing any activity by a first worker in any industrial floor, for various reasons, the quality of the activity may not be appropriate, or the first worker might have difficulty to perform the activity, and during that time, if multiple other second workers are performing similar activity, then there is a possibility by which the first worker can learn by observing from one or more second workers who are performing the activity at same point of time, so that, the first worker can observe the activity from the second worker and performing the activity with the required quality.

Current methods and systems of computer-implemented observational learning do not take into consideration the context, whether the activity is performed contemporaneously, and other environmental factors. This can lead to inefficient and ineffective learning environment. Additionally, increasing complexity of regulations and the requirements for occupational safety introduce more demands on systems.

The present disclosure provides a process (as well as a system, method, machine-readable medium, etc.) for Context Aware Observational and Group Learning Environment. An embodiment includes detecting a data request by a system. Embodiments disclosed herein describe the system as comprising a detection component, a neural network, an interactive environment, a component to determine a quality metric using the neural network and a component to determine a difference between the first quality metric and the second quality metric. It should be understood that the functions of the various components may be combined to result in fewer components. For example, in some embodiments, the neural network and a component to determine a quality metric may be combined into one component. Embodiments disclosed herein describe a neural network as using a machine learning algorithm to perform machine learning tasks including but not limited to predicting, clustering, and regression.

In embodiments, the system automatically detects a first profile performing an activity from sources where the first profile may comprise of data collected from sensors, including cameras, microphones, and network components however, use of this example is not intended to be limiting, but is instead used for descriptive purposes only. The terms “first profile”, “second profile”, and “third profile” may or may not comprise a person, or a robot. The term activity as used herein describes a task, job or something that requires exertion, time and energy to perform.

Embodiments disclosed herein describe determining using a trained first neural network a first quality metric of the first profile. A quality metric as described herein may comprise of a parameter, assessment, measure or score of the quality of the work performed by the profile of an activity.

In embodiments, a first neural network may be a machine learning model trained on historical data with criteria for assessing the quality of work performed on an activity, where the training comprises using known supervised machine learning techniques based on an attribute of a historical data as labels where the quality metric may be generated by machine learning algorithms. In another embodiment, a machine learning model may be trained with historical attribute metric, where the training comprises using known unlabeled unsupervised machine learning techniques.

The neural network may also be a Convolutional Neural Network (CNN) for image classification and object recognition tasks where an input may be the detected first profile.

In some embodiments disclosed herein the system may comprise of a plurality of machine learning models implemented in a sequence based on the machine learning algorithm, for example, a first machine learning model may implement a Gradient Boosting Machine, the second machine model may implement the Random Forest algorithm and the third machine learning model implements the deep learning algorithm.

Embodiments disclosed herein describe determining a second profile performing the activity and a second quality metric using a trained second neural network based on the first quality metric. In embodiments, the trained second neural network may comprise a machine learning model or a CNN trained to identify different types of industrial processes which are of high-quality standards.

Embodiments disclosed herein also describe transforming an interactive environment using a trained third neural network based on the first profile and the second profile wherein the interactive environment is transmitted to the first profile and the interaction is derived from at least a difference between the first quality metric and the second quality metric. An interactive environment as described herein may be a virtual environment where users are able to interact. The interactive environment may be accessed using general-purpose computers and smartphones, augmented reality, mixed reality, volumetric videos and virtual reality. The term “transforming” as used herein may mean to change, modify or add to an interactive environment including but not limited to audio and image manipulation, filtering and synthesis. In some embodiments, the transforming may be performed at least in part by a Generative Adversarial Network. The interaction may comprise of corrective suggestions by utilizing the conditional input including a difference determined between the first quality metric and the second quality metric.

Embodiments disclosed herein also describe determining the second profile is further based on a location of the first profile. The term “location” as used herein may describe the location of the activity in the industrial floor, or location of the activity in different plant, different geographic location.

Embodiments disclosed herein also describe the first profile and the second profile perform the activity contemporaneously. The term “contemporaneously” as used herein may describe the first profile and the second profile performing the activity at the same time or within a time offset such as a time offset that is predefined.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

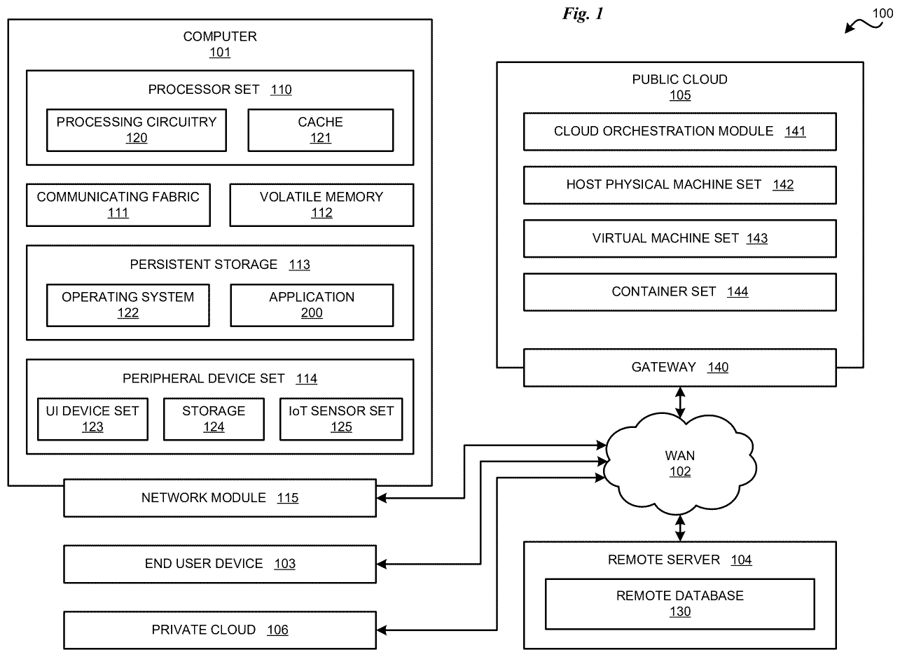

With reference to FIG. 1, this figure depicts a block diagram of a computing environment 100. Data center environment 100 contains an example of an environment for the execution of at least some of the computer code involved in performing the inventive methods, such as an Application module 200 that provides Context Aware Observational and Group Learning Environment. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

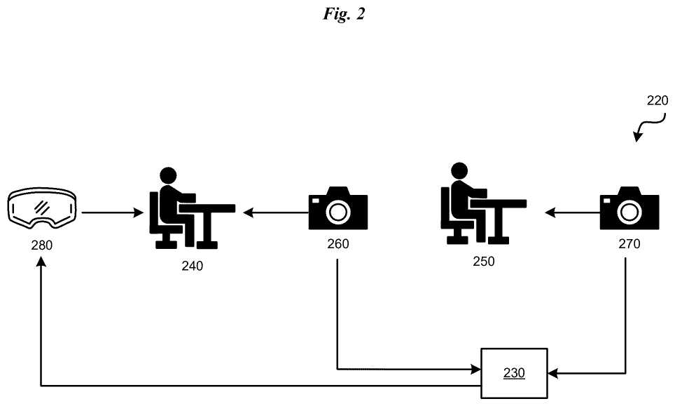

FIG. 2 depicts a block diagram of an environment in accordance with an illustrative embodiment. In a particular embodiment, the diagram 220 shows aspects of the application 200 of FIG. 1.

In the illustrated embodiment, a first profile performing an activity 240 is detected by a sensor 260 and received by the system. In embodiments, the system may be deployed in settings such as factories, construction sites, industrial floors or similar. In other embodiments, the sensors are deployed from multiple dimensions and types of data, which can include data collected from Internet of Things (IoT), cameras, microphones, monitoring systems, including environment data, device operation data, and inspection data.

In embodiments, a profile may or may not comprise a person, a worker or a robot. Additionally, the first profile may include attributes such as qualifications, skill level, work assignment. The activity may comprise a task, job or similar that requires exertion, time and energy to perform. For example, on any industrial floor, the first profile is a human worker may perform any activity in any industrial floor using different types of machines, tools or devices. The application 230 may analyze IoT and image analysis to identify what types of activity is being performed with the help of cameras and sensors.

In an embodiment, responsive to the detecting, a trained first neural network determines a first quality metric of the first profile. In embodiments, a first neural network may be a machine learning model trained on historical data with criteria for assessing the quality of work performed on an activity, where the training comprises using known supervised machine learning techniques based on an attribute of a historical data as labels where the quality metric may be generated by machine learning algorithms. In another embodiment, a machine learning model may be trained with historical attribute metric, where the training comprises using known unlabeled unsupervised machine learning techniques.

In another embodiment, the neural network may be a known Convolutional Neural Network (CNN) comprised of node layers, containing an input layer, one or more hidden layers, and an output layer. Each node connects to another and has an associated weight and threshold. If the output of any individual node is above the specified threshold value, that node is activated, sending data to the next layer of the network. Otherwise, no data is passed along to the next layer of the network. The convolutional layer is the first layer of a convolutional network. While convolutional layers can be followed by additional convolutional layers or pooling layers, the fully-connected layer is the final layer. With each layer, the CNN increases in its complexity, identifying greater portions of the image. Earlier layers focus on simple features, such as colors and edges. As the image data progresses through the layers of the CNN, it starts to recognize larger elements or shapes of the object until it finally identifies the intended object.

In another embodiment, a second profile performing an activity 250 is detected by a sensor 270 and is input into a trained second neural network. In an embodiment, the trained second neural network may be a CNN trained to identify different types of industrial processes which are of high-quality standards.

The Application 230 may further comprise an interactive environment 280. An interactive environment may be a virtual environment where users are able to interact. The interactive environment may be accessed using general-purpose computers and smartphones, augmented reality, mixed reality, and virtual reality.

In embodiments, application 230 further comprising machine learning models, storage and processor and graphical processor. In embodiments, machine learning models may comprise of a supervised learning model where the labeled data sets comprise attributes of historical data requests. As input data is fed into the model, it adjusts its weights until the model has been fitted appropriately. In an embodiment, the input data comprises training text, documents and images. For example, the documents may be historical attribute metrics of historical responses to data requests with associated confidence ratings. Supervised learning uses a training set to teach models to yield the desired output. This training dataset includes inputs and correct outputs, which allow the model to learn over time.

In some embodiments, the machine learning models comprise of an unsupervised learning model that is given raw unlabeled historical data. In embodiments, the model infers similarities and differences of the attributes of the historical data based on known methods such as clustering, association and dimensional reduction. It should be noted that in some embodiments, the machine learnings models may comprise of supervised and unsupervised learning models in combination.

In an embodiment, a feature vector represents a data request in a vector format where each element of the vector comprises a feature such as a particular attribute's occurrences in the data. In another embodiment, a feature vector comprises properties of the data representing the patterns in the data. For example, the feature vectors may comprise attributes of a plurality of historical data. The system performs matrix operations on a large amount of the data represented in the feature vectors to determine patterns in the data.

In embodiments, the machine learning model may implement a machine learning algorithm such as gradient boosting which is an ensemble machine learning technique that combines a collection of weak models into a single, more accurate and efficient predictive model. These weak models are typically decision trees, which is why the algorithms are commonly referred to as gradient boosted decision trees (GBDTs). Gradient boosting algorithms work iteratively by adding new models sequentially, with each new addition aiming to resolve the errors made by the previous ones. The final prediction of the aggregate represents the sum of the individual predictions of all the models. Gradient boosting combines the gradient descent algorithm and boosting method, with a nod to each component included in its name.

In an embodiment, the machine learning model implements linear regression which is used to identify the relationship between a dependent variable and one or more independent variables and is typically leveraged to make predictions about future outcomes. When there is only one independent variable and one dependent variable, it is known as simple linear regression. As the number of independent variables increases, it is referred to as multiple linear regression. For each type of linear regression, it seeks to plot a line of best fit, which is calculated through the method of least squares. However, unlike other regression models, this line is straight when plotted on a graph.

In another embodiment, the machine learning model implements a Random Forest model, a commonly-used machine learning algorithm, that combines the output of multiple decision trees to reach a single result. Random forests are made up of many decision trees, each of which is trained using a random subset of the training data. For example, a decision tree may be trained on a data request specific to a particular industry or organization. Random forest is used for both classification and regression purposes. The “forest” references a collection of uncorrelated decision trees, which are then merged together to reduce variance and create more accurate data predictions.

In some embodiments, the machine learning model may implement a deep learning model where the input layer of the deep learning model processes and passes the data request and response attributes to layers further in the neural network. These hidden layers process information at different levels, adapting their behavior as they receive new information.

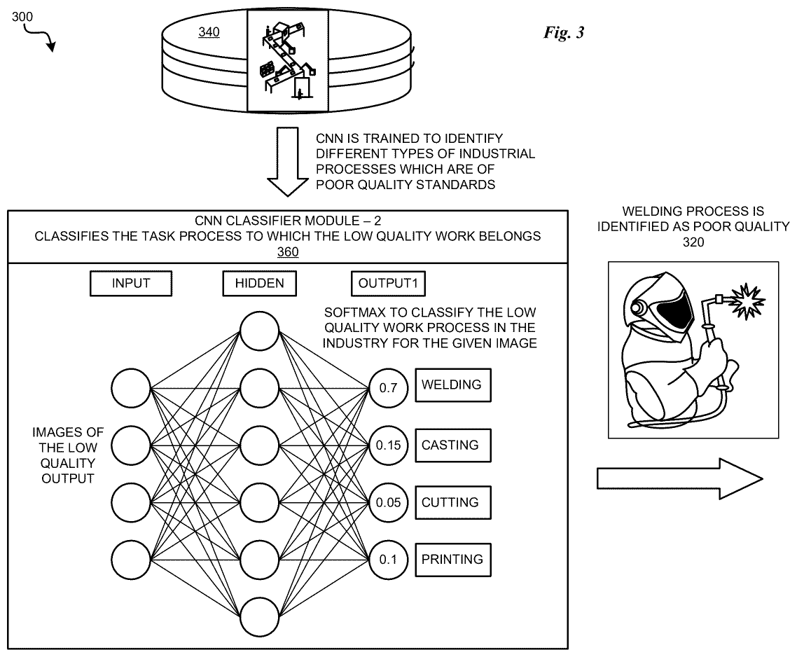

FIG. 3 depicts a block diagram of a first neural network in accordance with an illustrative embodiment. In a particular embodiment, the components of the diagram 300 shows aspects of the application 200 of FIG. 1.

In the illustrated embodiment, a first neural network 360 is trained on historical data 340 comprising different activities such as industrial processes that are of low quality standards. For example, the first neural network 360 is a trained CNN that receives a first profile 320 and determines a first quality metric based on whether the first profile performance of an activity is of poor quality. A quality metric as described herein may comprise parameters, assessment, measure or score of the quality of the word performed by the profile of an activity In another embodiment, the CNN works with another machine learning model to determine a first quality metric. In another example, an image of a worker performing an activity is passed through a layer of the CNN. A SoftMax function is computed by the CNN to output a second quality metric of the image comprising a low quality score for the activity such as welding, casting, cutting and printing depicted in the image.

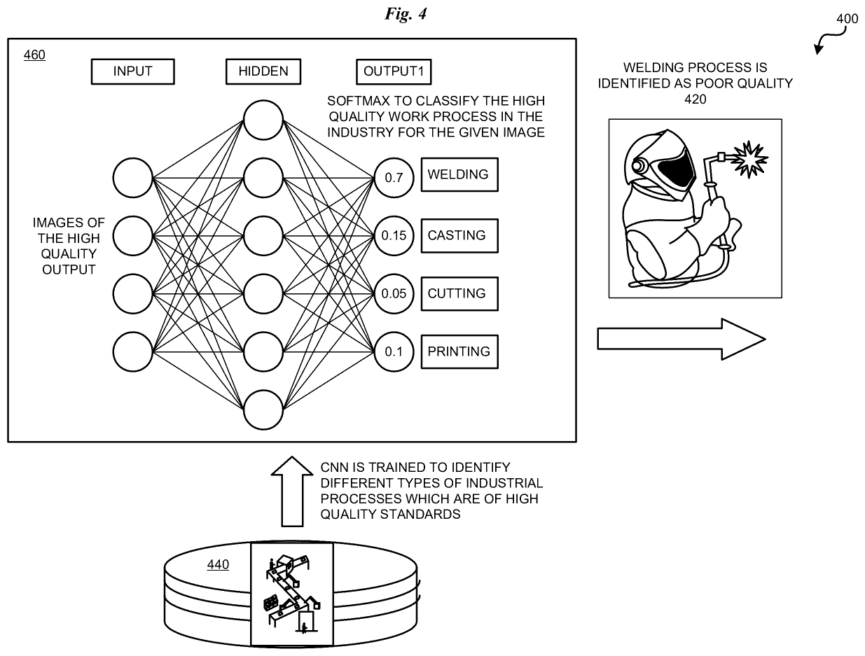

FIG. 4 depicts a block diagram of a second neural network in accordance with an illustrative embodiment. In a particular embodiment, the components of the diagram 400 shows aspects of the application 200 of FIG. 1.

In the illustrated embodiment, a second neural network 460 is trained on historical data 440 comprising different activities such as industrial processes that are of high quality standards. For example, the second neural network 460 is a trained CNN that receives a second profile 420 and determines a second quality metric based on whether the second profile performance of an activity is of high quality. In another example, an image of a worker performing an activity is passed through a layer of the CNN. A SoftMax function is computed by the CNN to output a second quality metric of the image that comprises a high quality score for the activity such as welding, casting, cutting and printing depicted in the image.

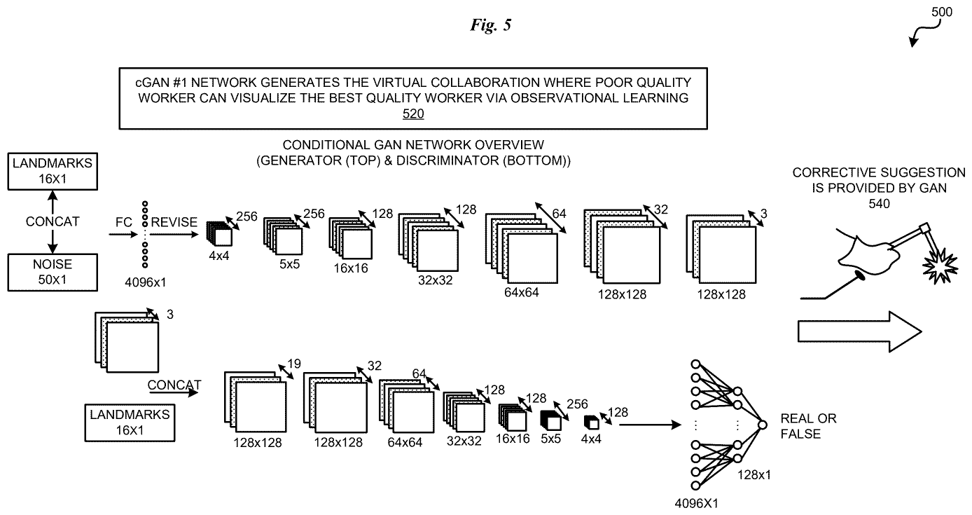

FIG. 5 depicts a block diagram of a third neural network in accordance with an illustrative embodiment. In a particular embodiment, the components of the diagram 500 shows aspects of the application 200 of FIG. 1.

In the illustrated embodiment, audio, images and/or videos of both the workers are passed into a third neural network 520 such as Generative Adversarial Network (GAN) which analyzes various features derived from the first quality metric of the first profile and the second quality metric of the second profile and generates a realistic virtual visualization of how the same task can be done in a much better way. In another example, a conditional generative adversarial network (cGAN) provides the context and guidelines for what kind of answer or output to produce. Instead of reaching out into random noise to provide an answer, a cGAN gives the network a condition or specific information about what kind of answer to produce. In an embodiment, the cGAN compares and derives the differences between the first quality metric of the first profile and the second quality metric of the second profile such as equipment used, body posture, and skill level to generate an interactive environment. The eGAN provides corrective suggestions where the conditional inputs are the derived differences.

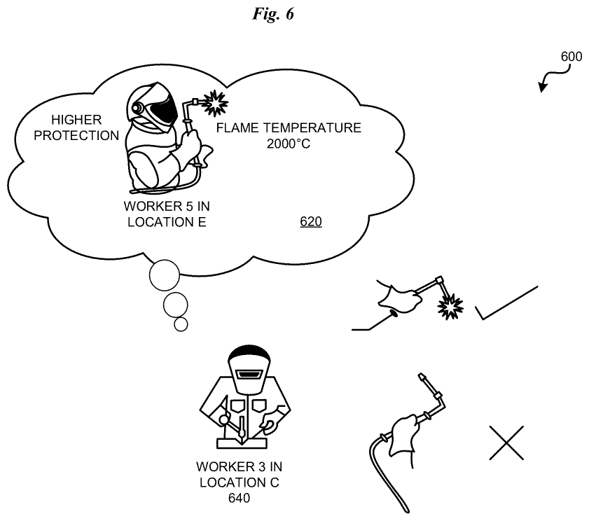

FIG. 6 depicts a block diagram of an interactive environment in accordance with an illustrative embodiment. In a particular embodiment, the components of the diagram 600 shows aspects of the application 200 of FIG. 1.

In the illustrated embodiment, an interactive environment showing an image of a high quality worker 620 visualized by a low quality worker 640. The term “transforming” as used herein may mean to change, modify or add to an interactive environment including but not limited to audio and image manipulation, filtering and synthesis. In some embodiments, the transforming may be performed at least in part by a Generative Adversarial Network. The interaction may comprise of corrective suggestions by utilizing the conditional input including a difference determined between the quality score of the first quality metric and the quality score of the second quality metric.

In an embodiment, the transformation uses a generator and a discriminator of the GAN or cGAN on an image of the low quality worker and image of the high quality worker to analyze, identify data attributes and distinguish between the attributes independently. The generator attempts to maximize the probability of mistake by the discriminator, but the discriminator attempts to minimize the probability of error. In iterations, both the generator and discriminator evolve and confront each other continuously until they reach an equilibrium state. In the equilibrium state, the discriminator can no longer recognize synthesized data. At this point, the process is over and the result is the transformation of an interactive environment comprising of an overlay of an image of the second profile in the interactive environment wherein the image is selected based on at least a difference between the first quality metric and the second quality metric.

In some embodiments, the low quality worker may interact in the interactive environment such as initiate a question, point or prompt with respect to an image. The system uses a GAN, cGAN, or a machine learning model to determine a response or output based on the question or prompt from the second profile. The processor of the system may interact with memory and a graphics processor to determine the placement of the response as an overlay in the graphical display including but not limited to augmented reality (AR), virtual reality, and device screens.

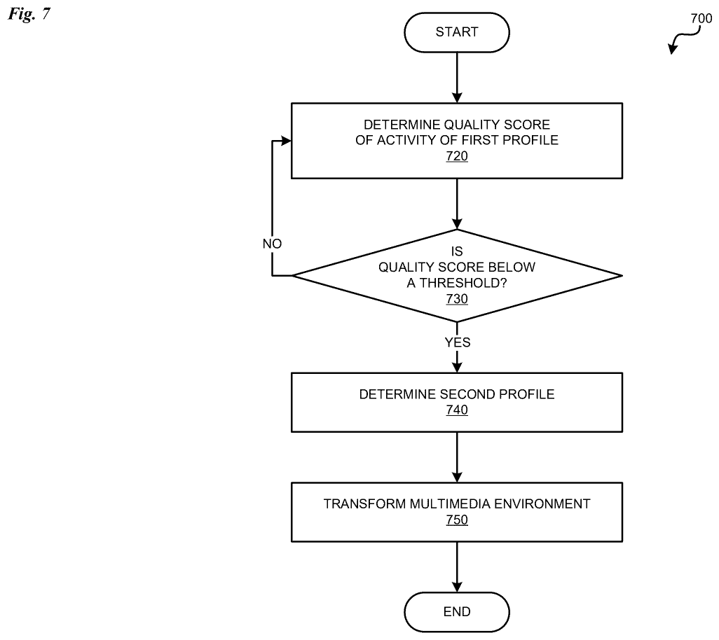

FIG. 7 depicts a flowchart diagram in accordance with an illustrative embodiment. In a particular embodiment, the components of the diagram 700 shows aspects of the application 200 of FIG. 1.

In the illustrated embodiment, the process starts with determining the quality score or metric of an activity of the first profile 720 that is detected from sources comprise of data collected from sensors, including cameras, microphones, and network components. The quality score or metric is determined using a first neural network that is trained on historical data comprising different activities such as industrial processes that are of low quality standards.

At step 730, a determination is made whether the quality score or metric is below a certain threshold. For example, analyzing the quality criteria are being performed by the human workers to identify what activity falls below the required quality criteria. If NO, the process repeats step 730. If YES, at step 740, the second neural network determines a second quality metric of a second profile based on whether the second profile performance of an activity is of high quality. In embodiments, the second profile is determined based on a location of the first profile. In another embodiment, the second profile is determined if it performs the activity contemporaneously with the first profile. At step 750, based on the first profile and the second profile an interactive environment is transformed using a trained third neural network.

In another embodiment, if the second profile is not available, the system sends a notification such as an email to available subject matter experts (SME) who are invited automatically to join the interactive environment with the worker of the first profile. For example, a list of SMEs may be maintained in a database and a determination made of the availability of each of the SMEs based on location and activity. In another example, one or more SMEs are included in the interactive environment by using a trained fourth neural network such as a GAN or cGAN. In some embodiments, the interactive environment enables interaction between SMEs and SME to the worker.

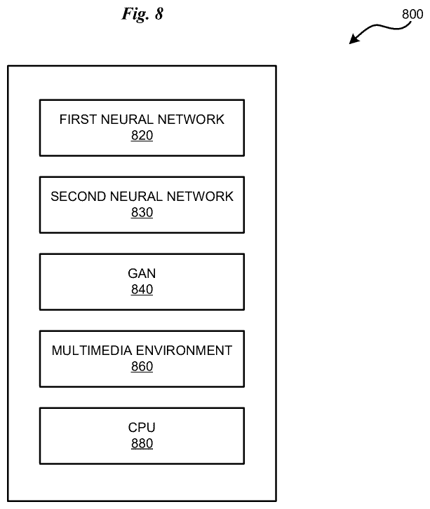

FIG. 8 depicts a system diagram in accordance with an illustrative embodiment. In a particular embodiment, the system components 800 are representative of aspects of the application 200 of FIG. 1.

In the illustrated embodiment, a system comprises a first neural network 820, a second neural network 830, a GAN 840, an interactive or multimedia environment 860 and a central processing unit (CPU) 880. In an embodiment, the system may comprise of data collected from sensors, including cameras, microphones, and network components. The network component may also include data aggregation layer that interacts with another component in the system. The neural networks 820, 830 and 840 may further comprise a machine learning models with an encoder-decoder architecture accepting input feature vectors to the machine learning model to perform predictions. Graphics Processing Units, (GPU) due to their ability to process tasks simultaneously, may be used for training the neural networks. By conducting numerous calculations at the same time, they can greatly decrease the processing time needed for the large volumes of data that machine learning models use. Tensor Processing Units, on the other hand, created specifically for executing machine learning tasks. Their ability to provide increased efficiency and speed while working with neural networks makes them a transformative technology for training machine learning models. The archive repository may be part of the system comprising in embodiments of database server or a storage device. In some embodiments, the functionality described herein is distributed among a plurality of systems, which can include combinations of software and/or hardware-based systems, for example Application-Specific Integrated Circuits (ASICs), computer programs, or smart phone applications.

The embodiments described herein may provide for exemplary system to detect a first worker performing an activity by a system in a factory setting, responsive to the detecting, determining using a trained first neural network a first quality metric of the first worker. The system determines a second worker performing the activity and a second quality metric using a trained second neural network based on the first quality metric. The system transforms an interactive environment using a trained third neural network based on the first worker and the second worker wherein the interaction is derived from at least a difference between the first quality metric and the second quality metric.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
determining by a system, responsive to detecting a first profile performing an activity, a first quality metric of the first profile using a trained first neural network;
determining based on the first quality metric, a second profile performing the activity and a second quality metric of the second profile using a trained second neural network; and
transforming, if the second profile is available, an interactive environment using a trained third neural network based on the first profile and the second profile wherein the transforming overlays an image of the second profile in the interactive environment wherein the image is selected based on at least a difference between the first quality metric and the second quality metric and the first profile and the second profile interact with the image.

2. The computer-implemented method of claim 1, further comprising determining a third profile if the second profile is unavailable wherein the interactive environment is transformed using a trained fourth neural network based on the third profile.

3. The computer-implemented method of claim 1, wherein determining the second profile is further based on a location of the first profile.

4. The computer-implemented method of claim 1, wherein transforming the interactive environment comprises comparing a body posture and a skill level of the first profile and the second profile.

5. The computer-implemented method of claim 1, wherein the first profile and the second profile perform the activity contemporaneously.

6. The computer-implemented method of claim 1, wherein the difference between the first quality metric and the second quality metric is determined by comparing a quality score.

7. The computer-implemented method of claim 1, wherein the trained third neural network is a Generative Adversarial Network.

8. A computer program product comprising one or more computer readable storage media, and program instructions collectively stored on the one or more computer readable storage media, the program instructions executable by a processor to cause the processor to perform operations comprising:
determining by a system, responsive to detecting a first profile performing an activity, a first quality metric of the first profile using a trained first neural network;
determining based on the first quality metric, a second profile performing the activity and a second quality metric of the second profile using a trained second neural network; and
transforming, if the second profile is available, an interactive environment using a trained third neural network based on the first profile and the second profile wherein the transforming overlays an image of the second profile in the interactive environment wherein the image is selected based on at least a difference between the first quality metric and the second quality metric and the first profile and the second profile interact with the image.

9. The computer program product of claim 8, further comprising determining a third profile if the second profile is unavailable wherein the interactive environment is transformed using a trained fourth neural network based on the third profile.

10. The computer program product of claim 8, wherein determining the second profile is further based on a location of the first profile.

11. The computer program product of claim 8, wherein transforming the interactive environment comprises comparing a body posture and a skill level of the first profile and the second profile.

12. The computer program product of claim 8, wherein the first profile and the second profile perform the activity contemporaneously.

13. The computer program product of claim 8, wherein the difference between the first quality metric and the second quality metric is determined by comparing a quality score.

14. The computer program product of claim 8, wherein the trained third neural network is a Generative Adversarial Network.

15. A computer system comprising a processor and one or more computer readable storage media, and program instructions collectively stored on the one or more computer readable storage media, the program instructions executable by the processor to cause the processor to perform operations comprising:
determining by a system, responsive to detecting a first profile performing an activity, a first quality metric of the first profile using a trained first neural network;
determining based on the first quality metric, a second profile performing the activity and a second quality metric of the second profile using a trained second neural network; and
transforming, if the second profile is available, an interactive environment using a trained third neural network based on the first profile and the second profile wherein the transforming overlays an image of the second profile in the interactive environment wherein the image is selected based on at least a difference between the first quality metric and the second quality metric and the first profile and the second profile interact with the image.

16. The computer system of claim 15, further comprising determining a third profile if the second profile is unavailable wherein the interactive environment is transformed using a trained fourth neural network based on the third profile.

17. The computer system of claim 15, wherein determining the second profile is further based on a location of the first profile.

18. The computer system of claim 15, wherein transforming the interactive environment comprises comparing a body posture and a skill level of the first profile and the second profile.

19. The computer system of claim 15, wherein the first profile and the second profile perform the activity contemporaneously.

20. The computer system of claim 15, wherein the difference between the first quality metric and the second quality metric is determined by comparing a quality score.
